(19) United States
(12) Patent Application Publication
(10) Pub. No.: US 2014/0050221 A1
(43) Pub. Date: Feb. 20, 2014

(54) INTERCONNECT ARRANGEMENT

(71) Applicants: Riccardo Locatelli, Fontanil (FR); Rene Peyard, Voiron (FR); Michael Bekerman, San Jose, CA (US)

(72) Inventors: Riccardo Locatelli, Fontanil (FR); Rene Peyard, Voiron (FR); Michael Bekerman, San Jose, CA (US)

(73) Assignees: STMicroelectronics, Inc., Coppell, TX (US); STMicroelectronics (Grenoble 2) SAS, Grenoble (FR)

(21) Appl. No.: 13/587,686

(22) Filed: Aug. 16, 2012

(51) Int. Cl. H04L 12/56

(52) U.S. Cl. 370/394

(57) ABSTRACT

An interconnect arrangement includes a plurality of tag allocators. Each tag allocator is configured to receive at least one stream of a plurality of packet units and further configured to tag each packet unit. Each packet unit is tagged with one of a set of n tags where n is greater than two. At least one stream is tagged with a sequence of tags that is different from a sequence of tags used for at least one other of said streams. The interconnect arrangement also includes a router configured to receive a plurality of streams of tagged packet units and to arbitrate between the streams such that packet units having a same tag are output in a group.

### BACKGROUND

1. Technical Field

Some embodiments relate to an interconnect arrangement which receives a plurality of data streams.

2. Description of the Related Art

A network on chip (NoC) uses packet based communication and a layered definition of the communication. Network on chips provide an interconnect between one or more initiators and their respective targets.

Quality of Service mechanisms are provided in order to arbitrate between requests for access to the network on chip.

U.S. Pat. No. 7,724,735 discloses an on-chip bandwidth allocator which allocates in real time shared resources of a network on chip.

### BRIEF SUMMARY

According to an embodiment, there is provided an interconnect arrangement comprising: a plurality of tag allocators, each tag allocator being configured to receive at least one stream of a plurality of packet units and to tag each packet unit, each packet unit being tagged with one of a set of n tags where n is greater than 2, wherein at least one stream is tagged with a sequence of tags which is different from a sequence of tags used for at least one other of said streams; and a router, said router configured to receive a plurality of streams of tagged packet units and to arbitrate between said streams such that packet units having a same tag are output in a group.

In some embodiments, the tagging sequence of at least one stream is different from another tagging sequence used for at least one other stream.

The sequence of tags may comprise m tags where m is less than n.

In some embodiments at least one stream may be tagged using two or more different sequences.

In some embodiments at least one stream may be tagged using a same sequence of tags a plurality of times

In some embodiments at least one sequence of tags comprises a different number of tags from a different sequence of tags.

In some embodiments at least one sequence comprises two or more of the same tag.

A first packet unit size on at least one data stream may be different from a second packet unit size on at least one other stream.

The first packet unit size may comprise one packet per unit.

The second packet unit size may comprise two or more packets per unit.

The packet unit size for a respective stream may be dependent on a bandwidth requirement of a source of said respective stream.

At least one stream may comprise a packet unit size of a packet and this stream may be tagged with a non-progressive sequence of tags where tags are dropped.

A plurality of interfaces may be provided, each interface comprising at least one tag allocator.

According to an embodiment, there is provided an apparatus comprising: a plurality of inputs each configured to receive a respective stream of a plurality of packet units, each packet unit being tagged with one of n tags where n is greater than 2, wherein at least one stream is tagged with a sequence of tags which is different from a sequence of tags used for at least one other of said streams; and an arbitrator configured to arbitrate between said streams such that packet units having a same tag are output in a group.

According to an embodiment, there is provided a router comprising: a plurality of inputs each configured to receive a respective stream of a plurality of packet units, each packet unit being tagged with one of n tags where n is greater than 2, wherein at least one stream is tagged with a sequence of tags which is different from a sequence of tags used for at least one other of said streams; and an arbitrator configured to arbitrate between said streams such that packet units having a same tag are output in a group.

According to an embodiment, there is provided a method comprising: receiving a plurality of streams of packet units; tagging each packet unit, each packet unit being tagged with one of n tags where n is greater than 2, wherein at least one stream is tagged with a sequence of tags which is different from a sequence of tags used for at least one other of said streams; and arbitrating between said streams such that packet units having a same tag are output in a group.

According to an embodiment, there is provided an interconnect arrangement comprising: tag allocator means for receiving a plurality of streams of a plurality of packet units and for tagging each packet unit, each packet unit being tagged with one of a set of n tags where n is greater than 2, wherein at least one stream is tagged with a sequence of tags which is different from a sequence of tags used for at least one other of said streams; and router means for receiving a plurality of streams of tagged packet units and for arbitrating between said streams such that packet units having a same tag are output in a group.

According to another embodiment, there is provided an apparatus comprising; an input configured to receive a stream of a plurality of tags; a tag allocator configured to allocate to each packet unit one of a set of n tags, where n is greater than two, wherein said packet units are tagged with a first sequence of tags and a second sequence of tags, said first sequence of tags being different from the second sequence of tags.

According to another embodiment, there is provided an interconnect arrangement comprising: a plurality of tag allocators, each tag allocator being configured to receive at least one stream of a plurality of packet units and to tag each packet unit, each packet unit being tagged with one of a set of n tags where n is greater than 2, wherein at least one stream is tagged with a sequence of tags which has dropped at least one of said set of tags; and a router, said router configured to receive a plurality of streams of tagged packet units and to arbitrate between said streams such that packet units having a same tag are output in a group.

At least one stream may be tagged with a plurality of sequences of tags, wherein at least two of said sequences are different.

### BRIEF DESCRIPTION OF SEVERAL VIEWS OF THE DRAWINGS

Non-limiting and non-exhaustive embodiments are described with reference to the following drawings, wherein like labels refer to like parts throughout the various views unless otherwise specified. The sizes, relative positions, and the particular shapes of the elements as drawn are not intended to convey any information regarding the actual shape of the particular elements and have been selected for ease of recognition in the drawings. One or more embodiments are described hereinafter with reference to the accompanying drawings in which:

FIG. 1 shows schematically part of an electronics device in which some embodiments may be provided;

FIG. 2 shows schematically a multimedia System On Chip arrangement in which some embodiments may be provided;

FIG. 3 shows schematically a proposal for allocation of traffic from different entities at a router;

FIG. 4 shows schematically an embodiment for allocation of traffic from different entities at a router;

FIG. 5 shows schematically blocks for implementing the embodiment of FIG. 4; and

FIGS. 6a, 6b show schematically another embodiment.

### DETAILED DESCRIPTION

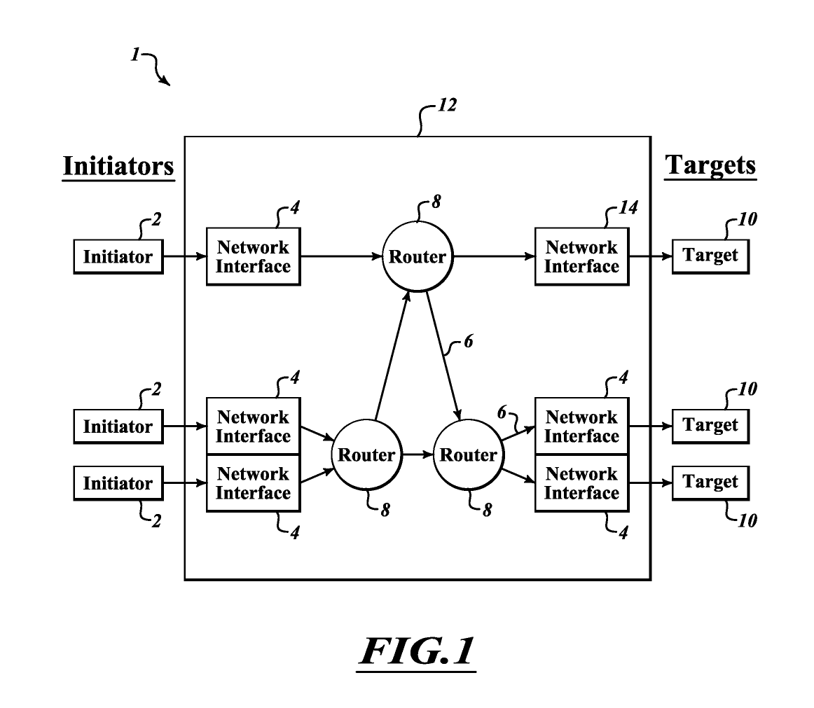

Reference is made to FIG. 1 which schematically shows part of an electronics device 1. At least part of the device shown in FIG. 1 may be provided in an integrated circuit. In some embodiments, all of the elements shown in FIG. 1 may be provided in an integrated circuit. In alternative embodiments, the arrangement shown in FIG. 1 may be provided by two or more integrated circuits. Some embodiments may be implemented by one or more dies. The one or more dies may be packaged in the same or different packages. Some of the components of FIG. 1 may be provided outside of an integrated circuit or die.

The device 1 comprises a number of traffic initiators (also known as a master or source) 2 which are configured to communicate with various targets (or destinations) 10 and vice versa. The initiators may be any suitable device and by way of example may be one or more of a CPU (central processing unit), transport stream processor, decoder, graphics processor, encoder, video display processor and graphics processor. It should be appreciated that these units are by way of example only and any other alternative or additional traffic initiator may be used. In the example shown in FIG. 1, there are three initiators 2. However, it should be appreciated that this is by way of example only and more or less than three initiators 2 may be provided.

By way of example only, the targets 10 may comprise one or more of a flash memory, a peripheral component interconnect (PCI), a double data rate memory (DDR) and an eRAM (embedded random access memory). It should be appreciated that these targets are by way of example only and any other suitable target may alternatively or additionally be used. More or less than the number of targets shown may be provided in other embodiments. In the example shown in FIG. 1, three targets 10 are shown. However, it should be appreciated that this is by way of example only and more or less than three targets 10 may be provided.

It should be appreciated that in some embodiments, a target 10 can be an initiator 2 and vice versa.

The various initiators and targets are able to communicate via a network on chip (NoC) 12. The NoC 12 comprises a respective interface 4 for each of the respective initiators 2. In some embodiments, two or more initiators 2 may share an interface 4. In some embodiments, more than one interface 4 may be provided for a respective initiator 2. Likewise, an interface 14 is provided for each of the respective targets 10. In some embodiments two or more interfaces 14 may be provided for a respective target 10. In some embodiments two or more targets 10 may share the same interface 14. The network interfaces 4, 14 are connected to one or more routers 8 via links 6. The routers are connected to each other via links 6. The network on chip 12 shown in FIG. 1 is simplified and shows three routers 8. In practice, the network on chip 12 may comprise many more than three routers 8. The topology may be regular, custom or any other suitable topology.

The arrangement shown in FIG. 1 can be considered to map onto a layered definition of communication. The links provide a physical and data link function. The router 8 provides a network function. The network interfaces 4, 14 provide a transport function. The services set applied on top of the network on-chip 12 can be considered to provide the application function.

The arrangement shown in FIG. 1 can be used to provide a hardware/software set of services on top of a distributed on-chip network, in some embodiments.

Embodiments may be used for quality of service for traffic management in System on Chip (SoC) interconnects. Some embodiments may be used for complex SoC interconnects.

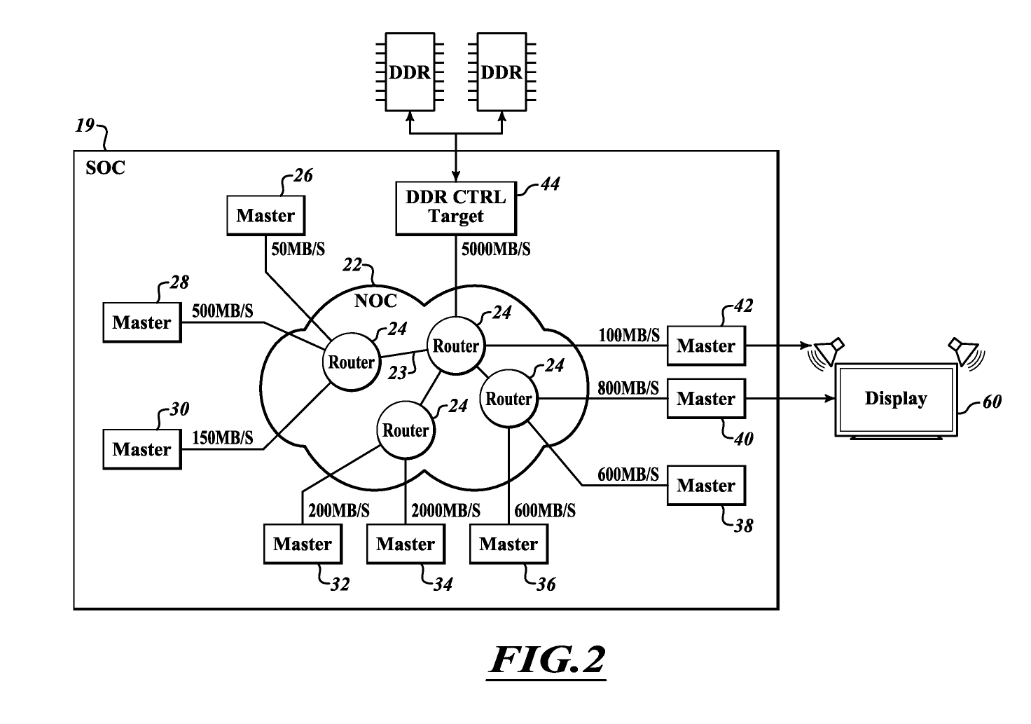

Reference is made to FIG. 2 which shows one application of an embodiment. In particular, in FIG. 2, an application to a multimedia use case is shown with a system on chip 19.

The system on-chip 19 has a network on-chip 22 having various routers 24.

The various routers 24 are connected by links 23. The following blocks are arranged to communicate via the network on-chip: first block 26, second block 28, third block 30, fourth block 32, fifth block 34, sixth block 36, seventh block 38, eighth block 40, ninth block 42 and a DDR controller 44. It should be appreciated that one or more of these entities may be an initiator and/or a target.

It should be appreciated that the various blocks that are shown are provided by way of example only and one or more of these blocks may not be present and/or replaced by one or more other blocks. It should be appreciated that the DDR controller target 44 is provided by way of example only. This target may be replaced by any other target. Alternatively or additionally any other suitable target may be used.

As illustrated in FIG. 2, different ones of the entities have different bandwidth requirements. The following table, Table 1, sets out the bandwidth requirements of the various entities.

TABLE 1

| | Bandwidth | |
|---|---|---|
| | (Megabytes/ | Percentage of the |
| Entity | second MB/s) | total bandwidth. |
| First block26 | 50 | 1% |
| Second block 28 | 500 | 10% |
| Third block 30 | 150 | 3% |
| Fourth block 32 | 200 | 4% |
| Fifth block 34 | 2000 | 40% |
| Sixth block 36 | 600 | 12% |
| Seventh block 38 | 600 | 12% |
| Eighth block 40 | 800 | 16% |
| Ninth block 42 | 100 | 2% |
| DDR controller | 5000 | 100% |
| (target) 44 | | |

It should be appreciated that the values given for the bandwidth are by way of example only and of course different entities may have different bandwidth requirements from those shown. In addition, the same entity may have different bandwidth requirements depending on the nature of the task being performed by the particular entity.

As can be seen, all of the entities require access to the NoC and have a varying range of bandwidth requirements. The smallest bandwidth requirement in the example shown is 50 MB/s while the highest bandwidth requirement is 2000 MB/s. This gives a ratio of high bandwidth to low bandwidth ratio of 40. In other words, the smallest resource required is around 1% and the largest resource required is about 40%.

The ratio is 40 between the lowest BW value and the highest one. One (the lowest) represents 1% of the total bandwidth and the highest is 40%.

It has been proposed to allocate bandwidth to a given target and to support different allocations for different targets. It has been proposed to control this with software programming after the silicon phase has been completed. Relatively simple software has been proposed. Consider the situation of four entities (initiators). The first entity requires 40% of the available target bandwidth, the second entity 20%, the third entity requires 10% and the fourth entity requires 30%. Each of these entities is provided with a weighting. Access to the network on chip would be controlled in dependence on these weights. The weights are used at the network injection points to properly tag the request packet header with quality of service information. This quality of service field of the packet header is used to drive properly the distributed arbitration points in each router of the network. Globally the weights determine the value of the quality of service header field, and this provides that at the target side the bandwidth percentages among the initiator traffic flows match the original requirements. The weights indicate units of bandwidth and are used as thresholds of the algorithm responsible for the quality of service field tagging, as summarized hereafter.

As far as the header quality of service field is concerned, packets are tagged with values 1 or 0, depending on the load/store operation size to be read or written at a specific target. There is a counter that counts the size of the requested operations until the given threshold (the weights) is reached, and after that it restarts counting again from zero. Each time a threshold value is reached, a quality of service tag value is changed. Packets injected are tagged with a specific quality of service tag value, until a threshold is reached; the next set of packets will be tagged with an opposite quality of service tag value.

Arbitration occurs in the routers at the network on chip packet granularity. In other words, each arbitrated request is equal to one NoC packet request. The packet size (that is the size of the read or write operation encoded in the request network packet) may be a system level constraint since it is directly linked to the DDR external memory access efficiency. In other words the system performance requirement and the external memory architecture mean that the packet size may be greater than a minimum value.

In a system shown in FIG. 2 the arbitration rounds may be relatively long because a relatively large number of packets have to be considered into a round to respect the bandwidth ratios, and this may result in an overall network high latency. Latency can be considered to result in low performance or high area cost due to bigger buffering requirements. Alternatively the rounds may be kept shorter, but the allocation may not respect the real bandwidth ratios and thus provide a coarse grain tuning, which may not be appropriate in some situations.

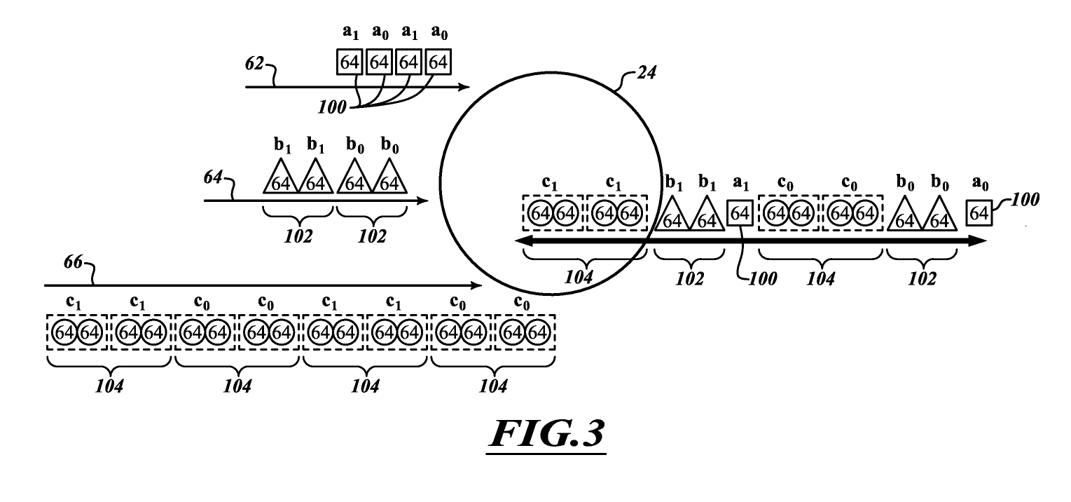

Reference is now made to FIG. 3 which illustrates the previously discussed scenario. The Network on Chip has a router 24. There are three entities 62, 64 and 66 which require access to this router 24. The first entity 62 has a first bandwidth of X. The second entity has a bandwidth of 2× and the third entity has a bandwidth of 4×. The unit size 100 for the first entity is 1 packet of size 64 B (Bytes). The second entity has a unit size 102 of 2×64 B. The third entity has a unit size 104 of 2×128 B. The output of the router 24 shows how the packets are arbitrated and hence how the bandwidth is allocated. Firstly, a packet “a” from the first entity is output followed by 2 packets “b” from the second entity followed by four packets “c” from the third entity. This provides an arbitration round duration of 7×64 B accesses. The arbitration round is linked to the round trip latency of each block accessing the memory though the network on chip.

The way packets are arbitrated depends on the quality of service tag in the header field that can assume either value 1 or 0 (represented in FIG. 3 as by the subscript 1 or 0). Router arbiter keeps together packets with the same quality of service value. When packets have the same “tag” any suitable algorithm can be applied to schedule packets. In FIG. 3, the packets are arbitrated by priority. The highest priority is given to the first entity 62, the next highest to the second entity 64, and the lowest priority to the third entity 66.

As will be described, some embodiments may provide a fine grain bandwidth allocation as a fraction of the network on chip packet size while keeping the network on chip packet atomicity for arbitration granularity. In some embodiments, this may allow allocation with full accuracy high bandwidth ratios as required by some systems such as that of FIG. 2 while keeping the arbitration round duration, and hence the latency relatively low.

Embodiments provide multiple tagging values that are used in the quality of service field of the packet header. The number of tags available is “n” where n is selected in dependence on the bandwidth ratios and/or the network packet granularity. The arbitration may occur in the router where resources are shared and thus conflict may be managed. The router arbiters will be configured to arbitrate together packets with the same tag. In this way the network will provide traffic where packets with same tags coming from different sources are injected to the final target.

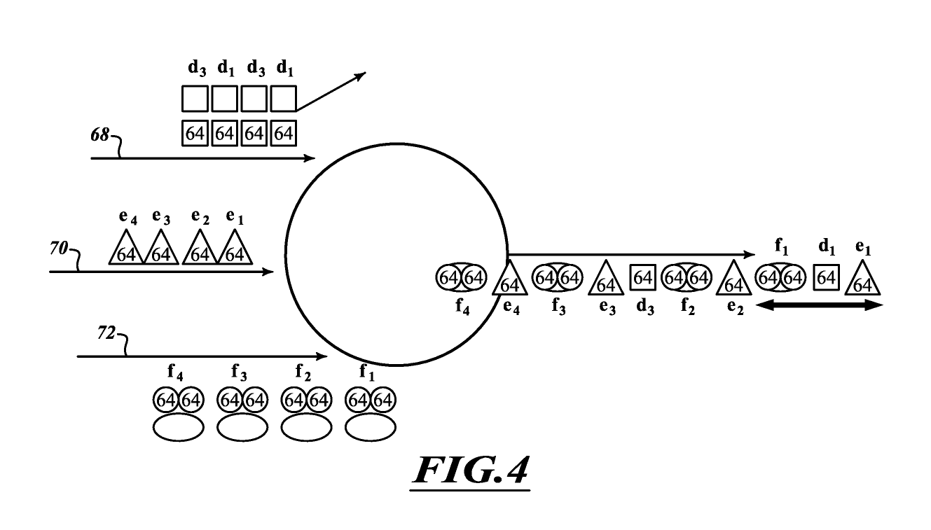

In some embodiments a tagging algorithm may be used at each injection point (initiator). This tagging algorithm may not use all the available tags for every initiator, as is shown in the embodiment of FIG. 4.

It should be appreciated that the tagging of the packets as illustrated in FIG. 4 will be performed by for example the network interface depending on the bandwidth and/or by an equivalent block at the injection side of the network. There may be a defined maximum set of tags n which, given a specific packet size, will be determined by the bandwidth allocation granularity, thus indirectly by the ratio between the smallest bandwidth requirement and the highest bandwidth requirement. The number of tags used for a particular entity among the maximum available tags n, will depend on the bandwidth requirement of the entity and can be as low as 1 and as high as n.

In some embodiments, an improved granularity may be provided. In the embodiment shown in FIG. 4, the first entity 68 has the smallest bandwidth requirement and is composed by packets of size 64 B. The second entity 70 has a bandwidth which is twice that of the first entity; the packet size produced by this second entity is still 64B. The third entity 72 has a bandwidth which is 4× that of the first entity while the packet size is 128 B, represented as 64+64 The maximum ratio that is to be managed by the allocation is 4 between entity 68 and entity 72. The basic packet size imposed by the system memory constraints is 64 B, i.e., the packet size of the entity 68. A “granularity” of 0.5 is set so as to be able to allocate the bandwidth as 0.5 fraction of the baseline packet size of entity 68, i.e., 0.5×64 B=32 B In other words, a threshold is set to 32 B. In this embodiment, this value may be the best trade off between arbitration round duration and quality of header field length. The maximum tag value n is represented in the quality of service header field as log(2) n bits.

It should be appreciated that in other embodiments, a different granularity is set. Some embodiments may have a granularity of less than one; that is, the threshold size may be smaller than the baseline packet size.

The traffic from the first entity 68 is a packet of 64 B so the threshold is half of this packet. For the second entity 70, the threshold is 1×64 B, because it has double the bandwidth requirement and hence double the threshold as compared to the first entity 68.

For the third entity 72, the traffic is in 128 B packets. The threshold will then be 1×128 B because the third entity 72 has four times the bandwidth requirement and hence four times the threshold as compared to the first entity 68.

In this example the traffic from each entity has up to four different tags which can be associated with it. With the first entity 68, only two tags out of 4 are used. This is because the threshold is 32 and with packets of size 64 B, two tags are consumed. As can be seen, the packets are alternatively tagged 1 and 3. Accordingly, the packets flow in the order d₁, d₃, d₁, d₃ (i.e., tag₁, tag₃, tag₁, tag₃).

The second entity 70 has each packet of size 64 B tagged with one of four tags. Accordingly, the traffic from the second entity is referenced e₁, e₂, e₃, e₄. The traffic from the third entity 72 is in packets of size 128 B. Accordingly, each packet will be tagged with tags 1 to 4. Accordingly, the traffic from the third entity 72 is referenced f₁, f₂, f₃ and f₄.

The router will first output all of the traffic tagged 1. Accordingly, the traffic is output from the router in the following order: e₁, f₁, d₁. The router will then output all of the traffic which is tagged with the number 2. Accordingly that is followed by traffic e₂ and f₂. The router will then output all of the traffic tagged 3 and will output the traffic e₃, f₃ and d₃. Finally, the router will output the traffic tagged 4 and will output the traffic e₄ and f₄. As can be seen, the embodiment of FIG. 4 has a round duration of 4×64 B accesses as compared to a round duration of 7×64 B accesses of FIG. 3. Reducing the round duration may allow a reduction in the latency for each initiator, since the relevant traffic is arbitrated more often at target side.

FIG. 4 shows one embodiment. In other embodiments there may be several arbitration stages (routers) in cascade. There may be many more initiators than the three shown. The amount of traffic to be arbitrated may be much greater. With these embodiments the reduction provided by embodiments in the round duration may provide bigger gains.

In one embodiment a counter is provided. Each time there is a request for a particular entity or initiator of the read/write operation, (that is the packet), the bytes are counted and an accumulated sum is provided in the counter. The counter is compared to a threshold.
If the sum counter is greater than the threshold or weight there is a tag swap event, and the next tag is computed as indicated in Table 2 below.
When a tag swap event occurs, the next tag is computed and an “Extra” variable is updated.
Extra will be reused as part of the sum counter for the subsequent transfer.
Extra counts by how much the threshold has been overpassed by the counter.

```
TABLE 2
If EXTRA is < THRESHOLD
    This EXTRA is reused in a subsequent tag assignment cycle
    Next tag is the previous tag + 1 MODULO N tag
    (For example if the THRESHOLD was 5 and the COUNT was 16,
    then EXTRA would be 11, and (1 MODULO 5) tag would then be 1)
ELSE
    EXTRA is not dropped but reduced by a value which is
    proportional with the number of jumped tags.
EXTRA (new) = EXTRA (old) − [round.inf(EXTRA /
THRESHOLD)* THRESHOLD]
    Next tag is the previous tag + [EXTRA / THRESHOLD] MODULO
    N tags
This would provide an algorithm,
# define TRANSFER_SIZE
# define THRESHOLD
# define NB_TAG
COUNTER = 0
SELECTED_TAG = 0
while not(break)
    if request_transfer == 1 then
        // Serve the request with current Tag
        COUNTER = COUNTER + TRANSFER_SIZE
        if COUNTER >= THRESHOLD then
            // Swap event
            // counter is assuming “extra” value
            COUNTER = COUNTER − round.down(COUNTER /
            THRESHOLD)* THRESHOLD
            // next tag selection
            TAG = modulo(TAG + round.down(COUNTER /
            THRESHOLD), NB_TAG)
        end if
    end if
end while
```

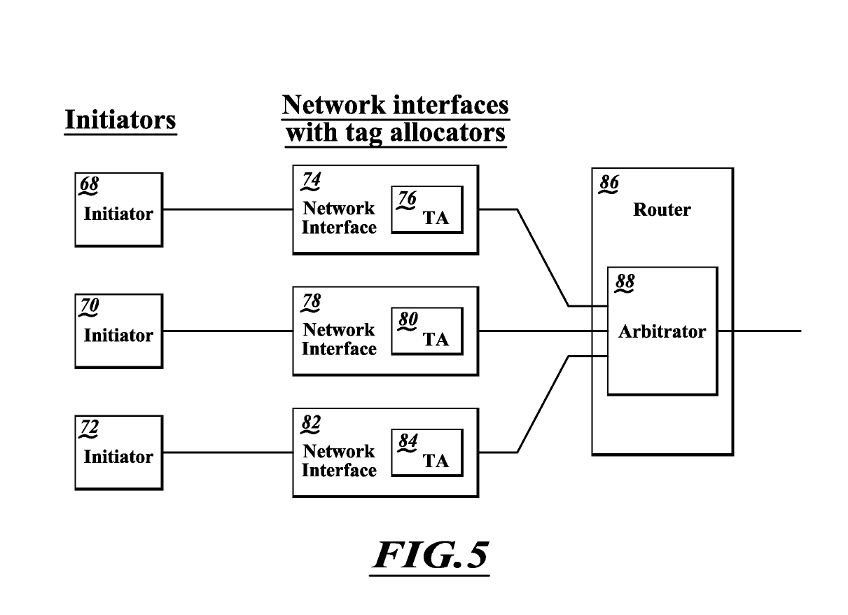

It should be appreciated that there may be alternative ways of allocating the tags in other embodiments. Reference is now made to FIG. 5 which shows the blocks associated with the embodiment illustrated in FIG. 4. The first entity 68 is arranged to provide an output to a first network interface 74. The network interface 74 has an allocator 76 which is configured to allocate tags to the packets output by the first entity 68. In some embodiments, the tag allocator 76 may be configured to carry out the above described algorithm (Table 2). In some embodiments, the tag information may be added to a header field of the data packet. It should be appreciated that in other embodiments, the packets may be tagged in any other suitable manner.

Likewise, the second entity 70 is arranged to provide an output to a second network interface 78. The second network interface 78 also has a tag allocator 80.

The third entity 72 provides an output to a third network interface 82. The third network interface 82 also has a tag allocator 84. The output of each of the first to third entities 74, 78 and 82 are provided to a router 86. In particular, the outputs are provided to an arbitrator 88 of the router which arbitrates between the three outputs to provide the output as shown in FIG. 4.

It should be appreciated that the arbiter 88 may be provided by one or more processors. The one or more processors may operate in conjunction with one or more memories.

It should be appreciated that the tag allocators 76, 80, 84 may be provided by one or more processors. The one or more processors may operate in conjunction with one or more memories.

In some embodiments, the one or more tag allocators 76, 80, 84 may be provided in the router 86. In some embodiments one or more tag allocators may be provided in the initiator 68, 70, 72 itself.

In some embodiments arbitration granularity is linked to transaction granularity versus bandwidth ratios among initiators. Some embodiments may be used with network on chip interconnects or any other suitable interconnect.

In some embodiments, arbitration granularity may be independent of the type of arbitration scheme. Some embodiments may be used with priority, weighted round robin or schemes such as the described bandwidth allocation scheme described above.

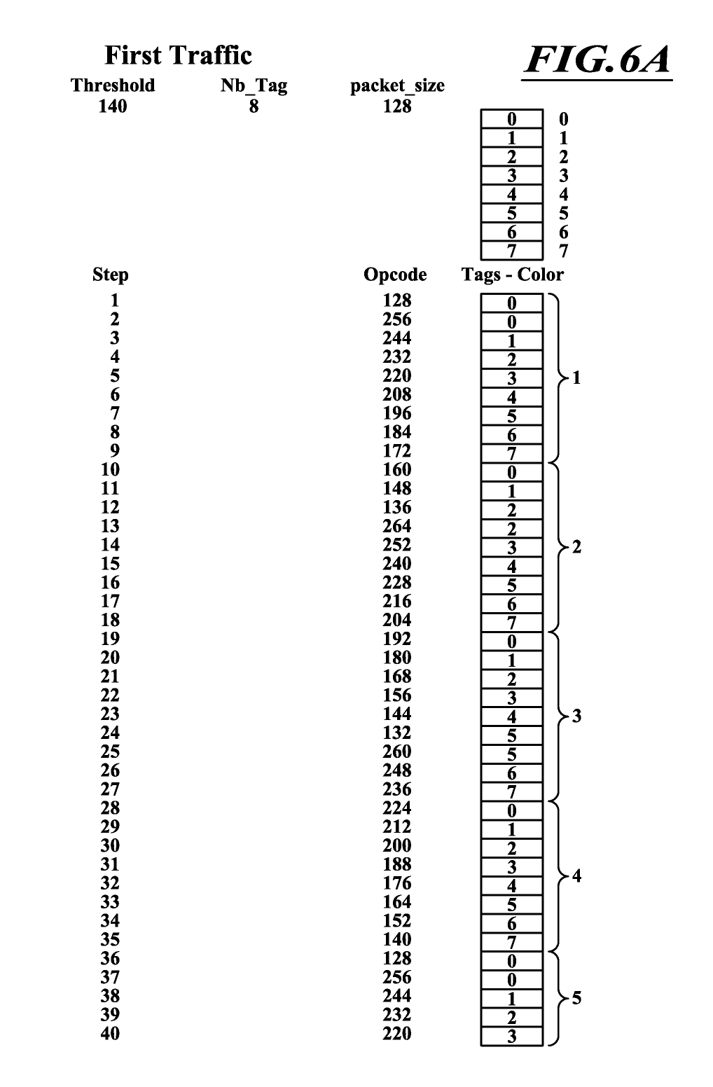

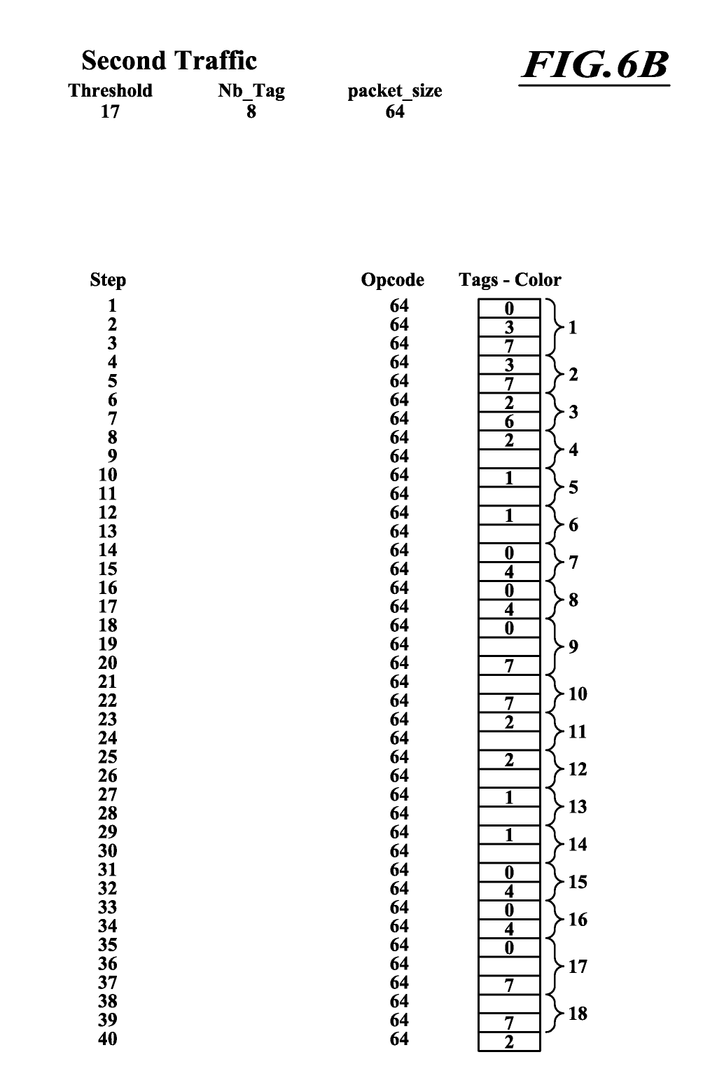

Reference is made to FIGS. 6a, 6b, which schematically show another embodiment. In FIGS. 6a, 6b respectively, a first traffic flow is shown along with a second traffic flow. Each of the packets is tagged with a tag from 0 to 7. In this example, the number of tags is equal to 8.

The second traffic flow (FIG. 6b) also uses the same set of tags. The tagging is done for example using the algorithm described above (Table 2). With the first traffic flow in FIG. 6a, all eight of the tags are used. Generally, each sequence of the tags includes all of the eight tags. However, some of the sequences include the same tag twice. For example, the first sequence includes the first tag, tag 0, twice. The second sequence includes the third tag, tag 2, twice. The third sequence includes the sixth tag, type 5, twice. Each of the sequences has been referenced from numbers 1 to 5 in FIG. 6. It should be noted that sequence 5 is not completed.

Reference is now made to the second traffic flow in FIG. 6b, which shows 18 sequences. Each of these sequences is much shorter. In general, each of the sequences either comprises two or three tags. As can be seen the sequences can be quite different. For example, the first sequence has the first, fourth and eighth tags, tag 0, 3 and 7. The second sequence has just the fourth and eight tags, tags 3 and 7. The third sequence has the third and seventh tags, tags 2 and 6. As can be seen, different tags of the eight available tags are dropped.

It should be realized that FIGS. 6a, 6b are by way of example only. Thus, in embodiments, a set of tags can be provided. The set of tags may have three or more tags. One or more of the traffic flows may use all of the available tags. However, alternatively or additionally, one or more of the traffic flows may only use a subset of the tags.

In some embodiments, two or more of the traffic flows will use a different tagging sequence.

It should be appreciated that in some embodiments, one or more of the tags may be dropped from a particular sequence. In the next sequence used for a particular traffic flow, the same or different one or more of the tags may be dropped.

In the embodiment described in relation to FIG. 6a and FIG. 6b, the sequence is defined as including packets with the sequence of tags from the lowest to highest. Alternative embodiments may define a sequence from the highest to the lowest. In other embodiments, the sequence may be defined differently such as to include a fixed number of tags. Alternatively or additionally, a sequence may be defined in any other suitable manner, which is independent of the numbering of the tags.

In some embodiments, n tags are used with a drop capability. A configuration of bandwidth requirement versus packet size may lead to the use, for each stream, of:
Up to n tags, which means to use
   always full sequence of n tags from 0 to n−1,
   or always the same m<n sequence,
   or the full n, but not in the sequence, meaning one or more tags is dropped, but not always the same one or more tags for all the streams. The packet unit size may be two or more packets.
Packet size Unit defined as number of packet tagged with the same tag can be
   0 when this tag is dropped,
   1,
   more.

Any combination of the previous alternatives is possible, for example all the streams with a packet unit size more than 1 and all n tags used but not in sequence or the like. For example—

Threshold=48 B, packets of the stream at 32 B and n=8 tags,

2 packets of 32 B tagged with tag0 (32+32−48=16=rest),

1 packet of 32 tagged with tag1 (16+32−48=0=rest),

2 packet of 32 B tagged with tag2 (32+32−48=16=rest),

And so on.

Embodiments may be applied in a wide range of technologies and applications. For example, embodiments may be used in a set top box, a Digital Television (DTV), and an application processor in a multimedia convergence application. Embodiments may be used in communications devices such as mobile phones, smart phones or the like. Embodiments may be used in any application domains where several initiators have to share the access to a shared target.

While this detailed description has set forth some embodiments of the present invention, the appending claims cover other embodiments of the present invention which differ from the describe embodiments according to various modifications and improvements. Other applications and configurations may be apparent to the person skilled in the art. Some of the embodiments have been described in relation to a number or masters and a DDR controller. It should be appreciated that this is by way of example only and the target may be any suitable entity. Alternative embodiments may use any suitable interconnect instead of the example Network-on-Chip.

The various embodiments described above can be combined to provide further embodiments. These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. An interconnect arrangement, comprising:
a plurality of tag allocators, each tag allocator being configured to receive at least one stream of a plurality of packet units and to tag each packet unit with one of a set of n tags where n is greater than two, wherein the tag allocators are configured to produce streams of tagged packet units having sequences of tags that are different from each other; and
a router configured to receive a plurality of streams of tagged packet units and to arbitrate between said streams such that packet units having a same tag are output in a group.

2. An interconnect as claimed in claim 1 wherein at least one sequence comprises m tags, where m is less than n.

3. An interconnect arrangement as claimed in claim 1 wherein at least one stream is configured to be tagged using two or more different sequences of tags.

4. An interconnect arrangement as claimed in claim 1 wherein at least one stream is configured to be tagged using a same sequence of tags a plurality of times.

5. An interconnect arrangement as claimed in claim 1 wherein at least one sequence of tags includes a different number of tags from a different sequence of tags.

6. An interconnect arrangement as claimed in claim 1 wherein at least one sequence of tags includes two or more of the same tag.

7. An interconnect arrangement as claimed in claim 1 wherein a first packet unit size on at least one data stream is different from a second packet unit size on at least one other stream.

8. An interconnect arrangement as claimed in claim 7 wherein said first packet unit size is one packet per unit.

9. An interconnect arrangement as claimed in claim 7 wherein said second packet unit size is at least two packets per unit.

10. An interconnect arrangement as claimed in claim 1 wherein said packet unit size for a respective stream is dependent on a bandwidth requirement of a source of said respective stream.

11. An interconnect arrangement as claimed in claim 1 comprising:
a plurality of interfaces, each interface including at least one tag allocator.

12. An apparatus, comprising:
a plurality of inputs, each input configured to receive a respective stream of a plurality of packet units, each packet unit being tagged with one of a set of n tags where n is greater than two, wherein at least one stream is tagged with a sequence of tags that is different from a sequence of tags used for at least one other stream; and
an arbitrator configured to arbitrate between said streams such that packet units having a same tag are output in a group.

13. An apparatus as claimed in claim 12 wherein the apparatus is a router.

14. A method, comprising:
receiving a plurality of streams of packet units;
tagging each packet unit with one of n tags where n is greater than two, wherein at least one stream of packet units is tagged with a sequence of tags that is different from a sequence of tags used for at least one other stream of packet units; and
arbitrating between said streams of packet units such that packet units having a same tag are output in a group.

15. A method as claimed in claim 14 wherein at least one sequence includes m tags, where m is less than n.

16. A method as claimed in claim 14 wherein at least one stream is tagged using at least two different sequences.

17. A method as claimed in claim 14 wherein at least one stream is tagged using a same sequence of tags a plurality of times.

18. A method as claimed in claim 14 wherein at least one sequence of tags includes a different number of tags from a different sequence of tags.

19. An interconnect arrangement, comprising:
a plurality of tag allocators, each tag allocator being configured to receive at least one stream of a plurality of packet units and to tag each packet unit, each packet unit being tagged with one of a set of n tags where n is greater than two, wherein at least one stream is tagged with a sequence of tags which has dropped at least one of said set of tags; and
a router, said router configured to receive a plurality of streams of tagged packet units and to arbitrate between said streams such that packet units having a same tag are output in a group.

20. An interconnect arrangement as claimed in claim 19 wherein at least one stream is tagged with a plurality of sequences of tags, wherein at least two of said sequences are different.

21. An interconnect arrangement as claimed in claim 19, comprising:
a plurality of network interfaces, each network interface including:
an input configured to receive a stream of a plurality of tags; and
a respective one of the tag allocators configured to allocate to each packet unit one of the set of n tags, wherein said packet units are tagged with a first sequence of tags and a second sequence of tags, said first sequence of tags being different from the second sequence of tags.
